(19) United States
(12) Patent Application Publication
(10) Pub. No.: US 2026/0122376 A1
(43) Pub. Date: Apr. 30, 2026

(54) LOGARITHMIC RESPONSE PIXEL FOR AN IMAGING DEVICE

(71) Applicant: STMicroelectronics International N.V., Geneva (CH)

(72) Inventor: Arthur ARNAUD, La Tronche (FR)

(73) Assignee: STMicroelectronics International N.V., Geneva (CH)

(21) Appl. No.: 19/364,314

(22) Filed: Oct. 21, 2025

(30) Foreign Application Priority Data
Oct. 24, 2024 (FR) 2411597

(51) Int. Cl. H04N 25/778; H04N 25/571; H04N 25/707

(52) U.S. Cl. CPC H04N 25/778; H04N 25/573; H04N 25/707

(57) ABSTRACT

A logarithmic response pixel includes a photosensitive circuit element and at least one diode-connected bipolar junction transistor. The at least one diode-connected bipolar junction transistor has a base coupled to a first conduction node of the at least one diode-connected bipolar junction transistor. A second conduction node of the at least one diode-connected bipolar junction transistor is coupled to a node of the photosensitive circuit element.

### PRIORITY CLAIM

This application claims the priority benefit of French Application for Patent No. FR2411597, filed on Oct. 24, 2024, the content of which is hereby incorporated by reference in its entirety to the maximum extent allowable by law.

### TECHNICAL FIELD

The present disclosure generally concerns pixels, electronic sensors comprising these pixels, as well as image acquisition devices comprising these sensors and their operating methods.

### BACKGROUND

Current image acquisition devices use optoelectronic sensors comprising pixels having their operation based on the detection of time variations to deduce therefrom edges of object in the acquired images. However, this implies implementing a large number of transistors, and the obtained performance in the presence of significant light variations is limited.

There exists a need to provide optoelectronic pixels and sensors enabling to detect the edges of objects, including in the presence of significant light variations, while decreasing the number of transistors involved.

There is a need to overcome all or part of the disadvantages of known pixels and sensors.

### SUMMARY

An embodiment provides a logarithmic response pixel having a photosensitive circuit element coupled to at least one diode-connected bipolar junction transistor.

An embodiment provides a method of operation of a pixel comprising the generation of a logarithmic response of a diode-connected bipolar junction transistor coupled to a photosensitive circuit element, as a result of the light excitation of the photosensitive circuit element.

According to an embodiment, the base and a conduction node of the bipolar junction transistor are coupled.

According to an embodiment, the photosensitive circuit element is coupled in series with the bipolar junction transistor between a first terminal and a second terminal, the second terminal being coupled to a terminal of application of a first reference voltage.

According to an embodiment, the first terminal is coupled to a terminal of application of a second reference voltage different from the first reference voltage.

According to an embodiment, the pixel comprises a first transistor, of MOS type, coupling the terminal of application of the second reference voltage and a first node coupled to a current source, a control node of the first transistor being coupled to the junction point of the photosensitive circuit element and of the bipolar junction transistor; the pixel preferably comprising a second transistor, of MOS type, coupling the first node to the current source, the current source preferably being coupled to a column of an optoelectronic sensor.

According to an embodiment, the pixel comprises: a first transistor, of MOS type, coupling the terminal of application of the second reference voltage and a first node, a second transistor, of MOS type, coupling the first transistor to a current source, and a third transistor in series with a storage capacitive element between the first terminal and the second terminal, a control node of the third transistor being coupled to the junction point of the photosensitive circuit element and of the bipolar junction transistor, a control node of the first transistor being coupled to the junction point of the third transistor and of the storage capacitive element, a fourth transistor coupling the junction point of the third transistor and of the storage capacitive element to the second terminal.

According to an embodiment, the pixel comprises a capacitive transimpedance amplification circuit stage coupling an event detection circuit stage and the first node, the event detection circuit stage being configured to modify a value of a storage bit as a function of the voltage present at the output of the capacitive transimpedance amplification circuit stage.

According to an embodiment, the event detection circuit stage comprises at least one comparator circuit configured to detect a variation of the output voltage of the capacitive transimpedance amplification circuit stage with respect to a threshold or a voltage range and reset the capacitive amplification circuit stage as a function of this variation.

According to an embodiment: the photosensitive circuit element is configured to photogenerate holes and is coupled in series with the bipolar junction transistor between a first terminal and a second terminal, the second terminal being coupled to a terminal of application of a first reference voltage; the bipolar junction transistor is a PNP-type transistor; and the base and the emitter of the bipolar junction transistor are coupled together to the second terminal, the photosensitive circuit element being, preferably, coupled to the first terminal and the first reference voltage being −VDD.

An embodiment provides an optoelectronic sensor comprising a pixel array having linear response pixels, for example of three transistor (3T), four transistor (4T), or five transistor (5T) type, and logarithmic response pixels such as described hereabove.

According to an embodiment, the logarithmic response pixels are arranged along diagonals of the array.

According to an embodiment, the sensor comprises: at least one subtractor circuit configured to perform a first subtraction of a voltage, present on the junction point of the photosensitive circuit element and of the bipolar junction transistor of a first logarithmic response pixel of the array, to a voltage present on the junction point of the photosensitive circuit element and of the bipolar junction transistor of a second logarithmic response pixel of the array; a comparator circuit configured to compare the result of the first subtraction with a first and with a second thresholds; and an event-based readout circuit coupled to the comparator circuit.

According to an embodiment, the sensor comprises: at least one subtractor circuit configured to perform a first subtraction of a voltage, present on the first node of a first logarithmic response pixel of the array, to a voltage present on the first node of a second logarithmic response pixel of the array; a comparator circuit configured to compare the result of the first subtraction with a first and with a second thresholds; and an event-based readout circuit coupled to the comparator circuit.

According to an embodiment: the subtractor circuit is further configured to perform a second subtraction of the voltage present on the junction point of the photosensitive circuit element and of the bipolar junction transistor of the second logarithmic response pixel, to a voltage present on the junction point of the photosensitive circuit element and of the bipolar junction transistor of a third logarithmic response pixel of the array; the comparator circuit being configured to compare the result of the second subtraction with said first threshold and with said second threshold.

According to an embodiment: the subtractor circuit is further configured to perform a second subtraction of the voltage present on the first node of the second logarithmic response pixel of the array, to a voltage present on the first node of a third logarithmic response pixel of the array; the comparator circuit being configured to compare the result of the second subtraction with said first threshold and with said second threshold.

According to an embodiment, the subtractor circuit comprises at least one differential amplifier having: an output coupled to the first terminal of the first pixel; an inverting input coupled to the junction point of the photosensitive circuit element and of the bipolar junction transistor of the first pixel; a non-inverting input coupled to the junction point of the photosensitive circuit element and of the bipolar junction transistor of the second pixel.

According to an embodiment, the subtractor circuit comprises at least one differential amplifier having: an output coupled to the first node of the first pixel via a first resistor; an inverting input coupled to the first node of the first pixel; and a non-inverting input coupled to the first node of the second pixel and to a terminal of application of a third reference voltage via a second resistor.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows an optoelectronic sensor in the form of a block diagram;

FIG. 2 shows a pixel of the sensor of FIG. 1;

FIG. 3 shows a pixel of the sensor of FIG. 1;

FIG. 4 shows a pixel of the sensor of FIG. 1;

FIG. 5 shows a pixel of the sensor of FIG. 1;

FIG. 6 illustrates a cross-section view of elements of a pixel of FIGS. 2 to 4;

FIG. 7 shows a pixel of the sensor of FIG. 1;

FIG. 8 shows an exploded view of an optoelectronic device;

FIG. 9 shows an optoelectronic sensor;

FIG. 10 shows an optoelectronic sensor;

FIG. 11 shows an optoelectronic sensor;

FIG. 12 shows an optoelectronic sensor;

FIG. 13 shows a pixel of the sensor of FIG. 1;

FIG. 14 shows an optoelectronic sensor;

FIGS. 15A to 15E show an optoelectronic sensor; and

FIG. 16 shows an optoelectronic sensor.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10% or 10°, preferably of plus or minus 5% or 5°.

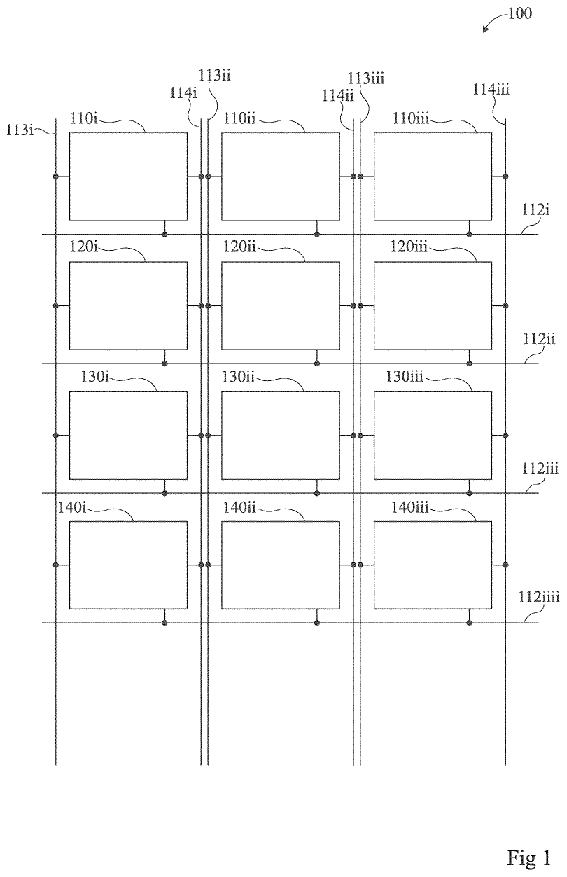

FIG. 1 shows an optoelectronic sensor (for example, comprising an imaging device or image sensor or image acquisition device) 100 in the form of a block diagram.

In the shown example, optoelectronic sensor 100 comprises pixels arranged in an array of four rows and three columns. This number of rows and columns is only provided as an illustration, and in reality the number of rows and columns is several thousand or even several hundred thousand. Pixels 110i, 110ii, 110iii are arranged in a first row and coupled, preferably connected, to a first horizontal track 112i of the array. Pixels 120i, 120ii, 120iii are arranged in a second row and coupled, preferably connected, to a second horizontal track 112ii of the array. Pixels 130i, 130ii, 130iii are arranged in a third row and coupled, preferably connected, to a third horizontal track 112iii of the array. Pixels 140i, 140ii, 140iii are arranged in a fourth row and coupled, preferably connected, to a fourth horizontal row 112iiii of the array. Pixels with index “i” are arranged in a same first column and coupled to at least one vertical track from among two separate tracks 113i and 114i. Pixels with index “ii” are arranged in a second column and coupled to at least one vertical track from among two distinct tracks 113ii and 114ii. Pixels with index “iii” are arranged in a third column and coupled to at least one vertical track from among two separate vertical tracks 113iii and 114iii. The output signals of each pixel are transmitted to the input of a network of analog/digital circuits, not shown, with electrical functions such as signal amplification, noise correction, signal filtering, as well as analog-to-digital conversion (ADC). Once the data have been acquired, there then remains to reconstruct an image for storage, processing, and/or display, depending on the application system.

All or part of the pixels of the array may implement an operation based on events (event-based pixels), such as light intensity changes. The pixels of the array may also be active pixels (APS).

The architecture of the active pixels may for example be a pixel architecture of 3T, 4T, or also 5T type, respectively implementing three, four, and five transistors. This architecture allows a linear response, that is, it provides at the pixel output a physical value, such as a voltage or a current, which varies linearly with illumination as long as there is no saturation.

To increase the dynamic range of sensors, that is, the range of maximum light intensity before saturation, it is possible to use a pixel architecture implementing a logarithmic response. In practice, such a pixel is obtained with a photodiode, biased to a VDD voltage, and which is coupled to a MOS transistor biased under its threshold voltage. This allows a logarithmic response, that is, it provides at the pixel output a physical value, such as a voltage or a current which varies according to a logarithmic law with illumination. The pixels thus implemented however have a noisy response due to thresholding effects. On the other hand, the dispersion, during the manufacturing, of the threshold voltages of the MOS transistors of the array pixels linked to logarithmic conversion, drastically limits the performance. The performance in low-light conditions is also penalized by the use of sub-threshold MOS transistors, which causes operating latencies.

Pixels 110i may, for example, be organized in an “interlaced” or “interleaved” array, some of them having an event-based operation and others being dedicated to a static operation.

In another, non-illustrated example, each pixel 110 (i, ii, iii), 120 (i, ii, iii), 130 (i, ii, iii), of image acquisition device 100 comprises a photodiode coupled to a circuit having a first architecture dedicated to an event-based operation and to another circuit having a second architecture dedicated to a linear operation. In this example, for each sensor, a switch directs the current photogenerated by the respective photodiode either to the pixel having the first architecture or to the pixel of the sensor having the second architecture. This enables to keep a high resolution, but does not allow simultaneous operation.

Depending on their architecture, pixels may have an asynchronous or synchronous operation. Asynchronous pixels require an address-event representation (AER), and pulses are sent each time an event, such as a change in light intensity, occurs. Synchronous sensors require, on the other hand, a storage, and at each pulse of a clock signal, data are sent or not, depending on the detection or on the non-detection of an event.

The various disclosed examples base the detection of events or of movements in a scene on temporal light variations, since the strong mismatch of sub-threshold MOS transistors makes pixel-to-pixel signal subtraction impossible. This has the disadvantage that the number of transistors implemented per pixel is greater than some ten, and that capacitive contrast amplifiers are necessary.

The use of standard pixels having a linear light intensity response does not enable to perform an efficient contrast detection, because in scenes where light intensity variations are significant, their low dynamic range may create saturated areas and many false events in bright areas, and blind them under a low light intensity.

To overcome the disclosed disadvantages, the embodiments provide using logarithmic response pixels having a photosensitive circuit element coupled to at least one diode-connected bipolar junction transistor (BJT).

The use of a diode-connected bipolar transistor is counter-intuitive, since for many years MOS or CMOS technology has been prioritized for pixel design. This is due to the fact that MOS transistors have a smaller size than bipolar transistors. Designers looking for miniaturization or higher resolutions have thus naturally developed systems based on MOS or CMOS technology. However, given the number of transistors per pixel which are used to process event-based information, the intrinsic advantage of MOS or CMOS transistors becomes limited. The use of a pixel with a diode-connected bipolar transistor, that is, having its base coupled, preferably connected, to one of its conduction nodes, has a significant advantage over MOS or CMOS transistors, which is that threshold voltage differences, due to dispersions during manufacturing, between two bipolar junction transistors, are much smaller than the dispersion of the threshold voltages of MOS transistors of a same array.

This enables to envisage a detection of spatial, and no longer temporal, light intensity variations, and which operates even when significant light variations are present in the scene, while only implementing a limited number of transistors.

In certain cases, this also enables to eliminate the need for capacitive amplification.

Even though bipolar transistors have a larger footprint on the surface of a chip than MOS transistors, the fact for the pixel using a diode-connected bipolar transistor to require a smaller total number of transistors enables, in fine, to improve the performance as compared with pixels based on MOS transistors, while obtaining an equivalent footprint.

The shown embodiments illustrate examples of implementations of logarithmic response pixels having a photosensitive circuit element coupled to at least one diode-connected bipolar junction transistor, that is, it is biased under its threshold voltage.

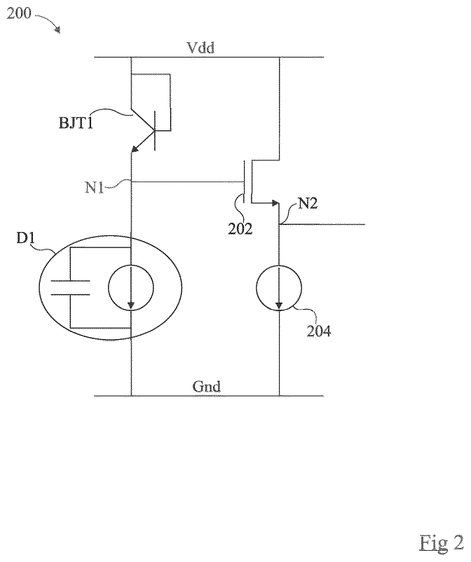

FIG. 2 shows a pixel 200 of the sensor 100 of FIG. 1.

More particularly, pixel 200 shows a possible implementation of all or part of pixels 110(i, ii, iii), 120 (i, ii, iii), 130 (i, ii, iii).

Pixel 200 comprises a photosensitive circuit element D1 coupled, preferably connected, at a node N1, to at least one diode-connected bipolar junction transistor BJT1, that is, in the illustrated example, its base is coupled to the collector. In other words, in operation, transistor BJT1 is biased below its threshold. The collector of transistor BJT1 is coupled, preferably connected, to a terminal of application of a reference voltage Vdd (also written VDD in the text). In the example of FIG. 2, transistor BJT1 is an NPN-type bipolar junction transistor.

Photosensitive circuit element D1 is, for example, a silicon-based photodiode or pinned diode, or a photodiode comprising nanoparticles forming a photosensitive layer. In the shown example, the photosensitive circuit element is shown by an equivalent circuit model of a capacitor in parallel with a current source coupling ground (Gnd) to node N1.

In the shown example, pixel 200 also comprises a transistor 202, for example of NMOS type, which is mounted as a source follower with its gate coupled, preferably connected, to node N1, a conduction node coupled, preferably connected, to the terminal of application of voltage Vdd, and another conduction node coupled, preferably connected, to a node N2. Node N2 is coupled, for example, to a grounding terminal by a current source 204.

In operation, the current generated by photosensitive circuit element D1 when it receives light becomes a voltage, at node N1, varying logarithmically with respect to the photogenerated current, due to the diode assembly of transistor BJT1. This logarithmic response can be read, to within voltage Vgs of transistor 202, on node N2.

By comparing these voltages between a plurality of pixels, it is possible to spatially deduce relative light intensity variations in a scene, and to obtain, for example, edges of object, and this is possible, even if the intensity variations are significant, since they are attenuated by the logarithmic function.

The example of FIG. 2 may form the first circuit stage of a dynamic vision sensor (DVS) and/or edge detection sensor.

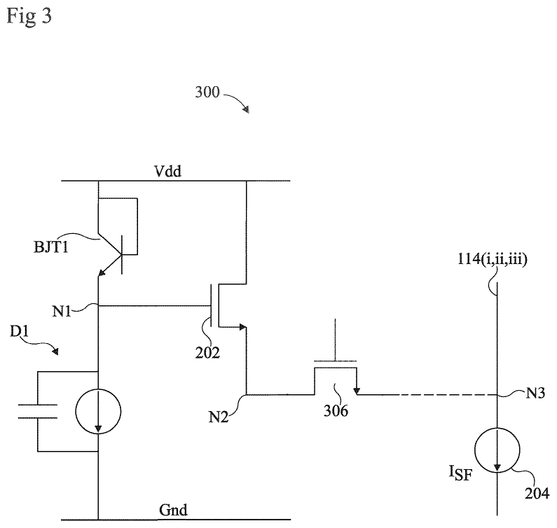

FIG. 3 shows a pixel 300 of the sensor of FIG. 1. More specifically, pixel 300 represents a possible implementation of all or part of pixels 110 (i, ii, iii), 120 (i, ii, iii), 130 (i, ii, iii).

Pixel 300 is similar to that of FIG. 2, except that pixel 300 comprises a transistor 306, which is used to select the row of the respective pixel array when it is activated. Transistor 306, which is, for example, an NMOS transistor, couples node N2 to current source 204. In the shown example, current source 204 is also coupled, preferably connected, to one of the columns 114 (i, ii, iii) of the array. Pixel 300 further couples node N2 to column 114 (i, ii, iii) at a node N3.

Pixel 300 forms what is can be referred to as a “3T” pixel, due to the use of three transistors, one of which is a bipolar junction transistor.

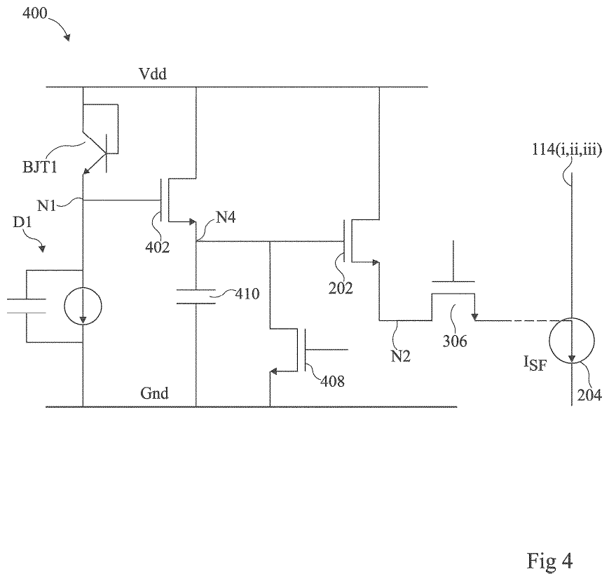

FIG. 4 shows a pixel 400 of the sensor of FIG. 1. More particularly, pixel 400 shows a possible implementation of all or part of pixels 110 (i, ii, iii), 120 (i, ii, iii), 130 (i, ii, iii).

The pixel of FIG. 4 is similar to that in FIG. 3 except that it comprises additional transistors 402 and 408, for example of NMOS type, and a capacitor 410.

Transistor 408 couples the control node of transistor 202 to the ground terminal. Capacitor 410 also couples the control node of transistor 202 to the ground terminal. Transistor 402 couples the terminal of application of voltage Vdd and the control node of transistor 202. The control node of transistor 402 is coupled, preferably connected, to node N1. Transistor 408 enables to reset the charges stored on capacitor 410.

Pixel 400 forms what can be referred to as a “5T” pixel, due to the use of five transistors. This type of pixel implements an integration circuit stage on capacitor 410 to decrease the sensitivity to noise.

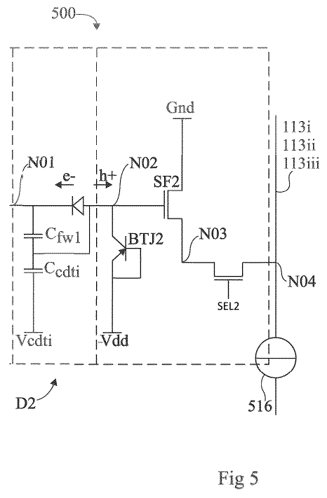

FIG. 5 shows a pixel 500 of the sensor of FIG. 1. More particularly, pixel 500 shows a possible implementation of all or part of pixels 110 (i, ii, iii), 120 (i, ii, iii), 130 (i, ii, iii).

Sensor 500 comprises a photosensitive circuit element D2 coupled, preferably connected, at a node N02, to at least one bipolar junction transistor BJT2, here of PNP type and diode-connected, that is, in the illustrated example, its base is coupled to the emitter. In other words, transistor BJT2 has a sub-threshold operating state. The emitter of transistor BJT2 is coupled, preferably connected, to a terminal of application of a reference voltage-VDD. Photosensitive D2 element is, for example, a silicon-based photodiode or pinned diode or a photodiode comprising nanoparticles forming a photosensitive layer.

In the shown example, pixel 200 also comprises a transistor SF2, for example of NMOS type, which is mounted as a source follower with its source coupled, preferably connected, to node N02, a conduction node coupled, preferably connected, to the terminal of application of ground or −VDD, and another conduction node coupled, preferably connected, to a node N03. A selection transistor SEL2 couples node N03 to a column 113 (i, ii, iii) of the pixel array at a node N04. In the shown example, a current source 516, for example similar to current source 204, is coupled to column 113 (i, ii, iii).

The photosensitive circuit element D2 of FIG. 5 comprises, for example, a photodiode having its cathode coupled, preferably connected, to a first electrode N01 and its anode coupled, preferably connected, to node N02. Photosensitive circuit element D2 further comprises a capacitive element Cfw1 (full well capacitance) corresponding to the capacitance of the depleted photodiode, in series with a capacitive element Ccdti, between the first electrode N01 and a terminal of application of a voltage Vcdti, corresponding to a biasing of a metal-oxide-semiconductor (MOS) capacitive element formed, for example, of heavily-doped polysilicon cores coated with oxide and with the silicon of the photodiode, the trench cores being biased (for example, using a Capacitor deep trench insulation (CDTI) configuration) with voltage Vcdti. The application of voltage Vcdti depletes the photodiode. A junction point of capacitive elements Cfw and Ccdti is coupled to node N02. When a photon is received by the photodiode, one or a plurality of electron-hole pairs are generated. The electrons (e−) are stored by capacitive element Cfw1, while the holes (h+) are stored on capacitive element Ccdti, which is for example implemented in the form of vertical areas doped, by implantation for example, with a P doping type, and biased with Vcdti. The holes end up on node N02, and the voltage at node N02 varies logarithmically according to the current of photogenerated holes.

This architecture enables to use the information provided by the photogenerated holes, rather than for them to be absorbed without use.

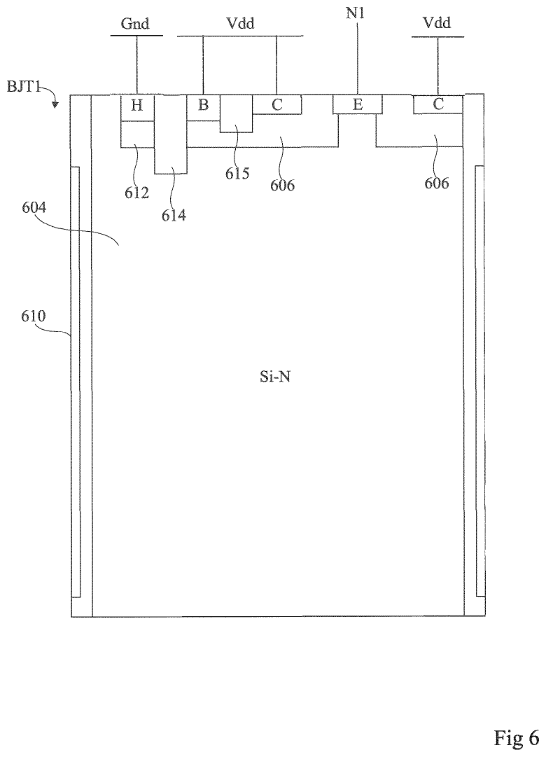

FIG. 6 illustrates a cross-section view of elements of a pixel of FIGS. 2 to 4. More particularly, the illustrated example is a cross-section of an example of implementation of bipolar junction transistor BJT1 with the photosensitive circuit element, here a photodiode. The shown example comprises a well 604 made of silicon (Si—N) doped according to a first doping type, for example N. This well forms a photodiode having photogenerated negative charges stored therein. Well 604 is laterally surrounded by capacitive deep trench isolation (CDTI) trenches 610.

An electrode His coupled to well 604 by a region 612 doped according to a second doping type, for example, P. Electrode H is configured to receive the holes H+ photogenerated in well 604 and collected in trenches 610 and discharge them to ground.

An electrode B, which forms the base of transistor BJT1, is coupled to well 604 by a region 606 doped according to the second doping type.

An electrode C, which forms the collector of transistor BJT1, is coupled to well 604 by the same region 606.

Region 606 also couples the collector to a region E which forms the emitter of transistor BJT1. Region E is also directly connected to well 604 on a lower portion of the electrode.

In the shown example, collector C is formed on either side of the emitter so as to laterally surround emitter E. In this case, region 606 laterally surrounds the emitter and couples it to the collector.

In the shown example, an insulating trench 614 is formed between electrode H and base B, and it vertically extends from the top of the base and of electrode H to well 604.

In the shown example, another insulating trench 615 is formed between collector C and base B. It extends vertically from the top of the base and of the collector until stopping in region 606 without running all the way to well 604.

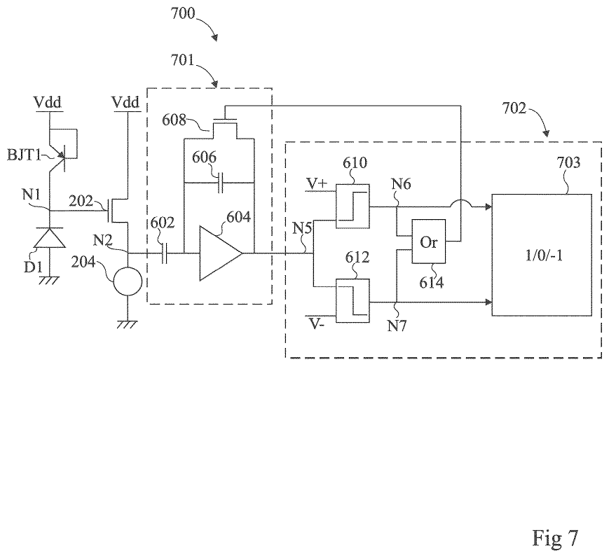

FIG. 7 shows a pixel 700 of the sensor of FIG. 1. More particularly, pixel 300 shows a possible implementation of all or part of pixels 110 (i, ii, iii), 120 (i, ii, iii), 130 (i, ii, iii).

Pixel 700 comprises the circuit 200 of FIG. 2 as well as a contrast amplification circuit stage 701 and an event detection circuit stage 702. Contrast amplification circuit stage 701 couples node N2 and event detection circuit stage 702.

In the shown example, contrast amplifier circuit stage 701 comprises a capacitive element 602 coupling node N2 to an input node of an amplifier 604. An output node N5 of amplifier 604 is coupled to its input node via a transistor 608, for example NMOS, in parallel with a capacitor 606. Transistor 608 is controlled by an output signal of event detection circuit stage 702 to perform a resetting of contrast amplification circuit stage 701.

Event detection circuit stage 702 comprises, for example, two comparators 610, 612 configured to compare the signal on node N5 with respectively a voltage V+ and a voltage V−, which define high and low thresholds. The respective output nodes N6 and N7 of comparators 610 and 612 are coupled to a logic block 614 (OR) configured to implement an OR-type logic function based on the signals present on nodes N6 and N7. The result of the OR function can be found on the control node of transistor 608. Transistor 608 is reset when at least one of the two thresholds V+ or V− is exceeded, or, for example, when the voltage on node N5 falls outside the voltage range defined by voltages V+ and V−.

Event detection circuit stage 702 further comprises a memory circuit 703, for example a register, having a storage bit (0, 1, −1) modified according to the results of comparators 610, 612.

The example in FIG. 7 enables to obtain an event-based sensor with a diode-connected bipolar transistor. This sensor enables to improve the issue of threshold voltage dispersion of event-based sensors having their pixels operating with one or a plurality of MOS transistors instead of the BJT1 bipolar junction transistor. This enables, in particular, to decrease false event detection.

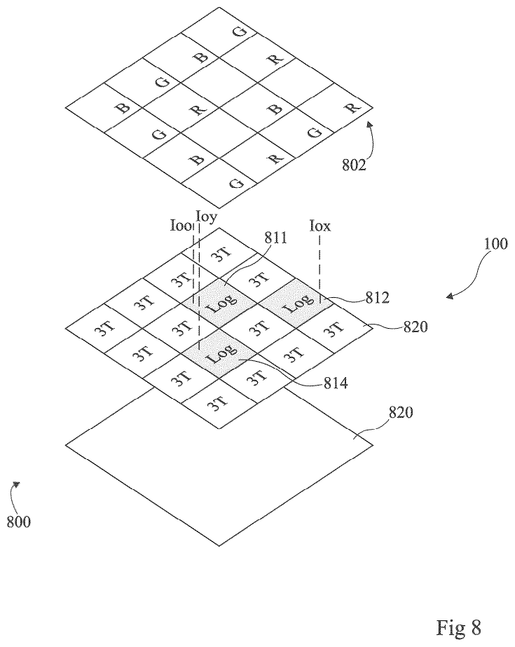

FIG. 8 shows an exploded view of an optoelectronic device 800.

The device 800 of FIG. 8 comprises, for example, the sensor 100 of FIG. 1, for which a first set 820 of pixels 110 (i, ii, iii), 120 (i, ii, iii), 130 (i, ii, iii), of the array comprises 3T-type pixels, each based on three MOS transistors, and a second set of pixels 811, 812, 814 of the array comprises logarithmic response pixels (log) such as those 200, 300, 400, 500, 700 of the examples of FIGS. 2, 3, 4, 5, and 7.

In the shown example, the pixels of the second set are arranged along all or part of the diagonals of the pixel array of sensor 100. In this example, a pixel 814 of the second set of pixels is arranged at a second row and a third column of a set of 4*4 pixels. A pixel 812 of the second set is arranged at a third row and a fourth column of the set of 4*4 pixels. A pixel 814 of the second set is arranged at a third row and a second column of the set of 4*4 pixels.

The example in FIG. 8 also comprises a Bayer grid 802, having its blue pixels for example represented by the letter B, their green pixels by the letter G, and their red pixels by the letter R. Bayer grid 802 has, vertically in line with pixels 811, 812, and 814, transparent portions with no color or with little color. Light intensity Ioo is received by pixel 811, light intensity Iox is received by pixel 812, and light intensity Ioy is received by pixel 814.

In the illustrated example, a bottom tier substrate 820 is arranged below the pixel array, in which, for example, subtractor circuits, logic processing circuits, or asynchronous read circuits (Address Event Representation (AER)) are arranged.

The shown example comprises a single 4*4 set of the pixel array, but the same architecture can be replicated across the entire pixel array.

The example of FIG. 8 enables to obtain both a color image of a scene and information relative to the edges of objects in this scene.

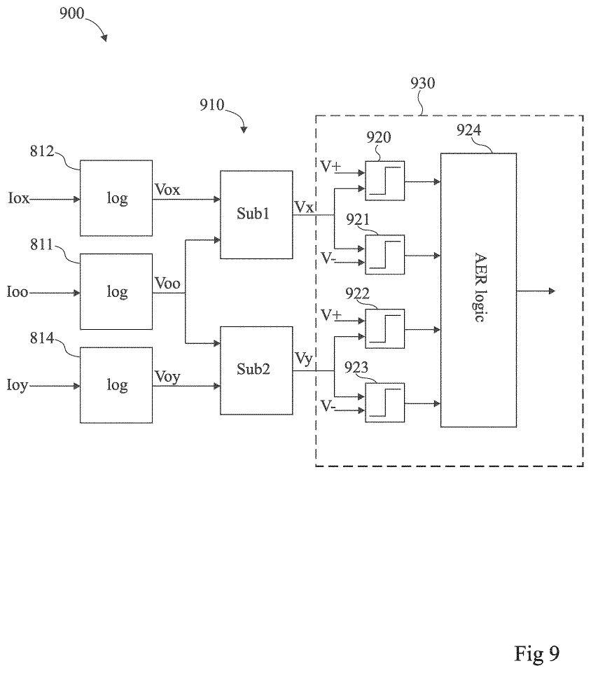

FIG. 9 shows an optoelectronic sensor 900. The example of FIG. 9 bears in particular on the processing of signals originating from the pixels 811, 812, and 814 of FIG. 8.

In the example of FIG. 9, pixels 812, 811, and 814 transform, with their respective diode-connected bipolar junction transistors, the light intensity received by the respective photosensitive circuit element. The voltages obtained at the respective nodes N2 are respectively noted Vox, Voo, and Voy. Voltages Vox, Voy, and Voo are logarithmic functions of the respective light intensities Iox, Ioo, and Ioy.

In the shown example, neighboring bipolar junction transistors located in two intersecting diagonals are associated with a subtractor circuit configured to amplify the signal differences of the two pixels of the two diagonals to measure the diagonal contrast. This enables to combine contrast information along two diagonals to perform a post-processing so-called “Roberts” pseudo-convolution to obtain the measurement of spatial contrast.

For this purpose, in the shown example, sensor 900 comprises a subtractor circuit 910 configured to perform a first subtraction Sub1=Vx=Vox−Voo=SS·log (Iox)−log (Ioo)=SS·log (Iox/Ioo) and optionally a second subtraction Sub2=Vy=Voy−Voo=SS·log (Ioy)−log (Ioo)=SS·log (Ioy/Ioo); where SS shows the slope under the threshold, and the sensitivity to light of the logarithmic circuit stage.

In the shown example, sensor 900 comprises a block 930 comprising a comparator circuit 920 configured to compare Vx with a first threshold V+, which is, for example, a voltage. Optionally, block 930 comprises a comparator circuit 921 configured to compare Vx with a second threshold V−.

In the shown example, block 930 comprises a comparator circuit 922 configured to compare Vy with threshold V+, which is, for example, a voltage. Optionally, block 930 comprises another comparator circuit 923 configured to compare Vy with the second threshold V−.

The results of comparators 920, 921, 922, and 923 are then processed, for example, by an event address representation block 924 (AER logic) for asynchronous reading and contrast detection.

Subtractor circuit 910 and block 930 enable to implement a spatial contrast detection on diagonals of the pixel array. This allows the implementation of the Roberts convolution based on the spatial contrast directly in the pixel array.

The following equations represent Roberts true convolution matrices along x and y axes of the pixel array:

$${G}_{x} = [ \begin{matrix}0 & - 1 \\ 1 & 0\end{matrix} ]$$

$${G}_{x} = [ \begin{matrix}- 1 & 0 \\ 0 & 1\end{matrix} ]$$

The following equations represent constraint matrices of Bayer grids 802:

$${G}_{x} = [ \begin{matrix}G & B & G \\ R & G & R \\ G & B & G\end{matrix} ]$$

$${G}_{y} = [ \begin{matrix}B & G & B \\ G & R & G \\ B & B & B\end{matrix} ]$$

The following equations represent the Roberts pseudo convolution matrices obtained are along the x and y axes:

$${G}_{x} = [ \begin{matrix}0 & 0 & - 1 \\ 0 & 1 & 0 \\ 0 & 0 & 0\end{matrix} ]$$

$${G}_{y} = [ \begin{matrix}- 1 & 0 & 0 \\ 0 & 1 & 0 \\ 0 & 0 & 0\end{matrix} ]$$

Roberts pseudo-convolution matrices are to be applied to the green pixels (Gx, Gy) with a contrast calculated along the x and y axes.

By using the norm of the vector defined by Gx and Gy and by comparing it with a threshold N, it is possible to obtain a motion-sensitive edge detection sensor also capable of providing an autofocus capability.

The subtractor circuit(s), for example, are integrated into the same substrate as the pixels, as a portion of the pixel circuits.

In an example, the bipolar junction transistors of the pixels are formed in a top tier substrate, and the subtractors and blocks 930 are formed in another substrate (bottom tier). The two substrates are coupled by copper pillars, for example.

The example of FIG. 9, although shown for a set of three logarithmic response pixels having a bipolar junction transistor, can be duplicated for other sets of three logarithmic response transistors having a bipolar junction transistor arranged within the pixel array.

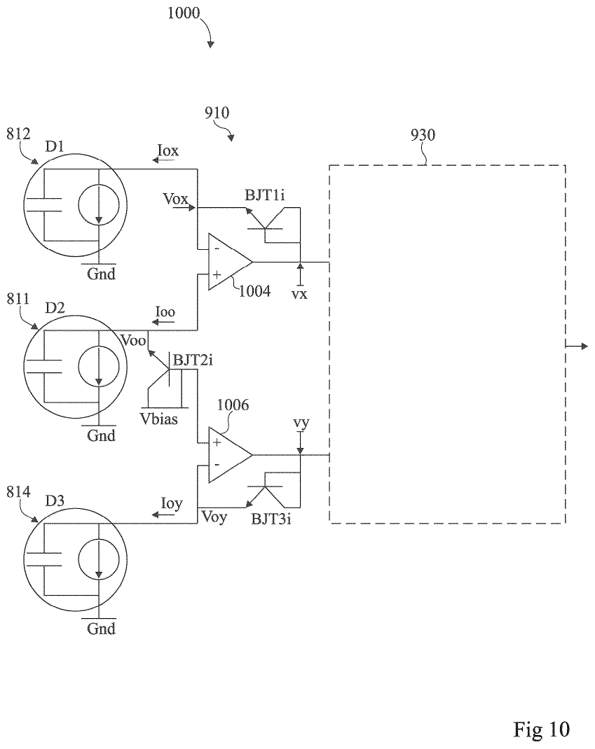

FIG. 10 shows an optoelectronic sensor 1000.

More particularly, the optoelectronic sensor 1000 of the example of FIG. 10 is similar to sensor 900 with an example of the implementation of subtractor 910.

In the example of FIG. 10, pixel 812 comprises photosensitive circuit element D1 coupled in series with bipolar junction transistor BJT1i. The base of transistor BJT1i is coupled to its collector. Voltage Vox can be found at the junction point of transistor BJT1i and of photosensitive circuit element D1.

In the example of FIG. 10, pixel 811 comprises another photosensitive circuit element D2 coupled in series with a bipolar junction transistor BJT2i. The base of transistor BJT2 is coupled to its collector. Voltage Voo can be found on the junction point of transistor BJT2i and of photosensitive circuit element D2. In this example, the collector and the base of transistor BJT2i are coupled to a terminal of application of a voltage Vbias.

In the example of FIG. 10, pixel 814 comprises a photosensitive circuit element D3 coupled in series with a bipolar junction transistor BJT3i. The base of transistor BJT3i is coupled to its collector. Voltage Voy can be found on the junction point of transistor BJT3i and of photosensitive circuit element D3.

In the illustrated example, subtraction Sub1 is obtained with a differential amplifier 1004 having an inverting input coupled to the junction point of transistor BJT1 and of photosensitive circuit element D1, and a non-inverting input coupled to the junction point of transistor BJT2 and of photosensitive circuit element D2. The collector and the base of transistor BJT1 are coupled to an output of amplifier 1004 so that voltage Vx is obtained at the output of amplifier 1004.

In the shown example, subtraction Sub2 is obtained with a differential amplifier 1006 having an inverting input coupled to the junction point of transistor BJT3i and of photosensitive circuit element D3, and a non-inverting input coupled to the base of transistor BJT2i. The base, the collector of transistor BJT2i, and a terminal of application of a voltage Vbias are coupled together. The collector and the base of transistor BJT3i are coupled to an output of amplifier 1006 so that voltage Vy is obtained at the output of amplifier 1006.

In this example, transistors BJT1i, BJT2i, and BJT3i are not only used for the logarithmic response, but they are also used as resistors for subtraction operations Sub1 and Sub2, which provides a compact layout.

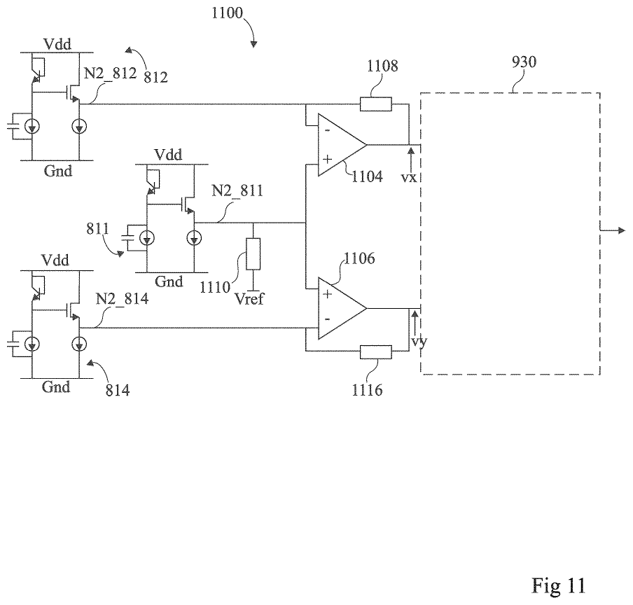

FIG. 11 shows an optoelectronic sensor. More particularly, the example of FIG. 10 shows sensor 900 with an example of subtractors 910.

In the shown example, pixels 811, 812, and 814 are each similar to pixel 200. The equivalents to node N2 of the pixel of transistors 811, 812, and 814, are respectively called N2_811, N2_812, and N2_814.

In the shown example, subtraction Sub1 is achieved with a differential amplifier 1104 having an inverting input coupled to node N2_812 and having an output coupled to node N2_812 via a resistor 1108. In this example, a non-inverting input of amplifier 1104 is coupled to node N2_811. Node N2_811 is further coupled to a terminal of application of a voltage Vref or Vbias via a resistor 1110.

In the shown example, subtraction Sub2 is obtained with a differential amplifier 1106 having an inverting input coupled to node N2_814 and having an output coupled to node N2_814 via a resistor 1116. In this example, a non-inverting input of amplifier 1106 is coupled to node N2_811.

In this example, pixels 811, 812, and 814 are formed in a substrate (top tier), and the circuits performing the subtractions as well as block 930 are formed in a bottom tier substrate. These two substrates are, for example, coupled by copper pillars. This enables to decrease the surface footprint of the edge detection sensor.

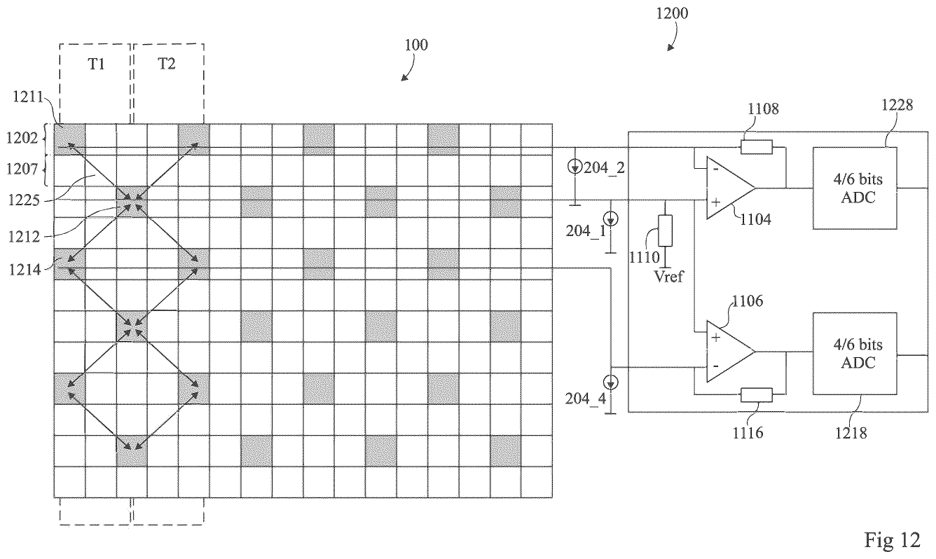

FIG. 12 shows an optoelectronic sensor 1200. More particularly, sensor 1200 comprises a pixel array where a set of horizontal rows 1202 comprises an alternation of a logarithmic-response pixel 1211 (shown shaded), such as for example that of FIG. 3, and of four active pixels (APS) of 3T or 4T or 5T type, only based on MOS transistors and with no bipolar junction transistors (shown unshaded). A second set of rows 1207 only comprises pixels of 3T or 4T or 5T type, only based on MOS transistors, with no bipolar junction transistors. The first and second sets of rows 1202, 1207 alternate vertically so that, in the shown pixel array, the logarithmic response pixels of rows 1202 having logarithmic response pixels, are arranged along diagonals of the array.

In the shown example, contrast amplification and logic processing circuits are arranged at the end of the array columns.

In the shown example, the logarithmic response pixels 1211, 1212, 1214, located on two intersecting diagonals, form a triangle 1225 together vertically and are each coupled to respective current sources 204_2, 204_1, 204_4.

In the case where the logarithmic response pixels 1211, 1212, 1214 of the sets of rows 1202 are each similar to the pixel of FIG. 3, pixel 1211 has its node N2 coupled to an inverting input of differential amplifier 1104 as described in FIG. 11 for example, pixel 1212 has its N2 node coupled to a non-inverting input of differential amplifier 1104, and an output of amplifier 1104 is coupled to the node N2 of pixel 1211 via resistor 1108, as shown in FIG. 11. As shown in FIG. 11, the node N2 of transistor 1212 is coupled to the terminal of application of voltage Vref via resistor 1110. Pixel 1214 has its node N2 coupled to an inverting input of differential amplifier 1106 as described in FIG. 11, for example. The non-inverting inputs of amplifiers 1104 and 1106 are coupled together, and the output of amplifier 1106 is coupled to its inverting input via resistor 1116 as shown in FIG. 3. The outputs of amplifiers 1104 and 1106 are respectively connected to analog-to-digital converters (ADCs) 1228, 1218 (4/6-bit ADCs).

In the example of FIG. 12, in the case where the logarithmic response pixels are similar to the example of FIG. 3, their transistor 306 is used to successively send the signals of the neighboring logarithmic response pixels comprising bipolar junction transistors to the subtractor.

In a first time sequence T1, a first column containing vertical triangles, such as the triangle formed by logarithmic response pixels 1211, 1212, and 1214, is read out. Then, in a second time sequence T2, an adjacent column containing vertical triangles formed by the logarithmic response pixels is read out, and so on for the entire pixel array.

By alternating the reading, contrasts can be alternately measured along a first diagonal and then a second diagonal.

Analog-to-digital converters 1228, 1218 (4/6-bit ADC), which have, for example, relatively a low 4/6-bit resolution, enable to detect contrasts if the current differences in pixels due to manufacturing are comparable to the contrast threshold.

In the case where current differences due to manufacturing are small as compared with the contrast threshold, a converter with only two bits is sufficient, or two comparators instead of four are sufficient per triangle.

Such an architecture enables to decrease the pixel complexity, to obtain a smaller footprint, to curb power consumption by pooling subtractors, and also enables to increase the resolution.

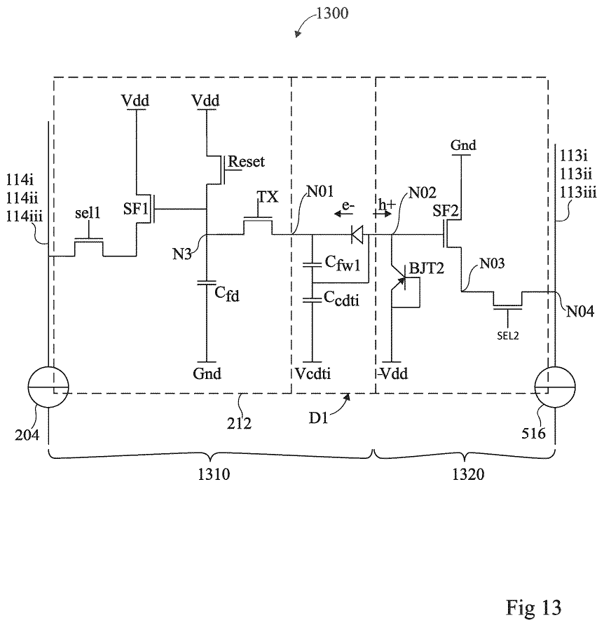

FIG. 13 shows a pixel 1300 of the sensor of FIG. 1.

Pixel 1300 is similar to that shown in FIG. 5, except that a circuit 1310, similar to a 4T-type MOS active pixel, is additionally coupled to node N01.

Circuit 1310 comprises a transistor sell, for example of NMOS type, coupling column 114i, ii, iii to a conduction node of a transistor SF1, for example of NMOS type. Transistor SF1 has another conduction node, for example coupled to the terminal of application of the second reference voltage VDD. Circuit 1310 further comprises a transistor Reset, for example of NMOS type, coupling the terminal of application of the second reference voltage VDD to ground GND via a capacitive element Cfd. The control node of transistor SF1 is coupled, preferably connected, to the junction point N3 of transistor Reset and of capacitive element Cfd. A transistor TX, for example of NMOS type, further couples node N3 and node N01.

In an example, circuit 1310 as well as photosensitive circuit element D1 are arranged in a first substrate (top tier). A portion 1320 of the pixel, comprising transistor BJT2, transistor SF2, and transistor Sel2, is arranged in another substrate (bottom tier). These two substrates are, for example, coupled by copper pillars.

In a non-illustrated example, the nodes N02 of a plurality of, for example, four, adjacent photosensitive circuit elements are coupled in parallel and are coupled to a single circuit 1320. This enables to combine (binning) the intensity of the hole currents of a plurality of adjacent pixels, for example.

The example of FIG. 13 enables to obtain both an image generated from the photogenerated electrons and a contrast image on the same image simultaneously, due to the use of the photogenerated holes and to the use of the bipolar junction transistor processing these photogenerated holes.

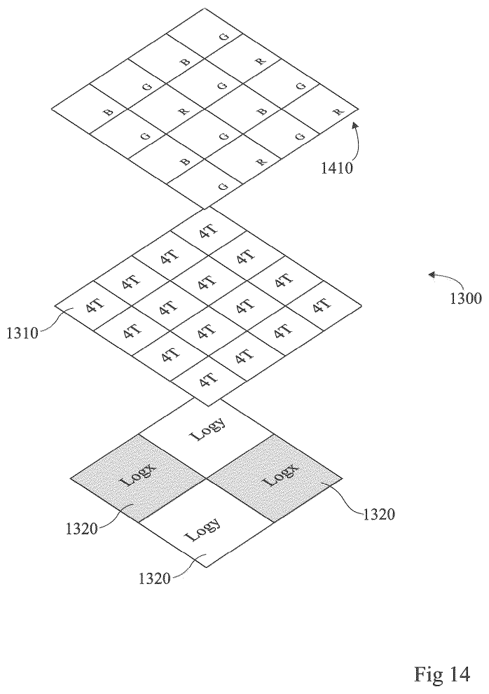

FIG. 14 shows optoelectronic sensor 1300. More particularly, FIG. 14 shows the arrangement of the circuits 1310 and 1320 of FIG. 13 within a sensor.

In the shown example, the sensor comprises a Bayer grid 1410 which overlies a pixel array such as that of FIG. 13. Circuits 1310, noted “4T”, as well as the photosensitive circuit elements D1 of the pixels are each arranged vertically in line with one of the color filters of Bayer grid 1410 and this, in a first substrate (top tier). Circuits 1320, noted “Logx” and “Logy”, are arranged in a bottom tier substrate located under the first substrate. Circuits 1320, noted “Logx”, are arranged along a first diagonal, and circuits 1320, noted “Logy”, are arranged along a second diagonal at 90° with respect to the first one. In the disclosed example, each circuit 1320 has a footprint equivalent to four of circuits 1310. In other words, the hole voltages or currents originating from four photosensitive circuit elements of circuits 1310 are added together and used by a single circuit 1320.

Although this is not shown, the outputs of circuits 1310 are coupled to a synchronous readout circuit and an analog-to-digital converter (ADC), for example over 12 bits. The outputs of circuits 1320 are coupled to subtractors such as for example those shown in FIG. 10, 11, or 12.

An advantage of using bipolar junction transistors, as in circuits 1320 enables to limit threshold voltage dispersions due to manufacturing and to have a minimum current close to that under low light intensity conditions. Another advantage is that the outputs of the analog-to-digital converters correspond to the threshold voltage dispersions due to manufacturing. Further, output variations around average values correspond to contrast detection.

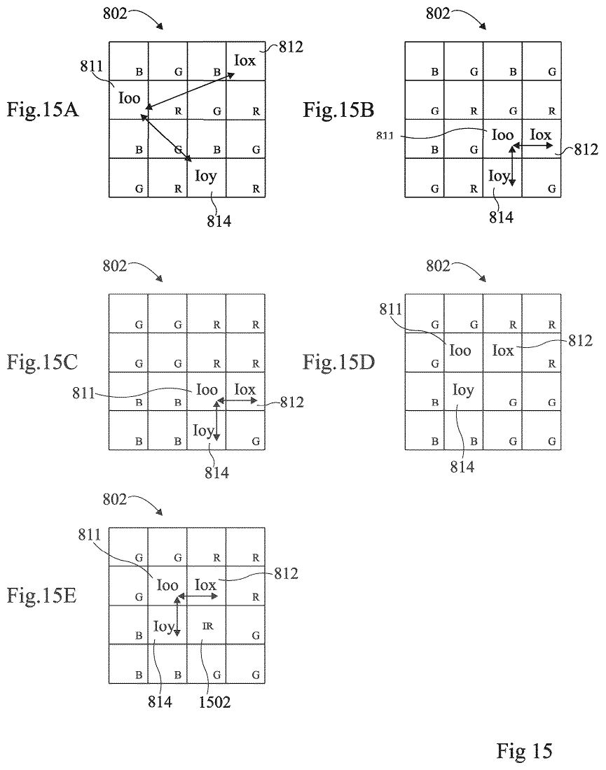

FIGS. 15A to 15E show an optoelectronic sensor. More particularly, FIGS. 15A to 15E show possible alternative arrangements of the pixels 811, 812, 814 of FIG. 8. These different arrangements enable to perform an autofocusing.

In the example of FIG. 15A, pixel 811 is located in the top right corner of a set of 4*4 pixels, pixel 812 is located on the second row and on the left-hand edge of this set of 4*4 pixels, and pixel 814 is located on the bottom row in the third column. In this example, the other pixels are of “3T”, or “4T”, or “5T” type with no bipolar junction transistors and are alternately dedicated, in the set of 4*4 pixels, to the green, blue, and red colors.

In the example of FIG. 15B, pixel 811 is located in the third row and the fourth column of the 4*4 pixel array. In this example, pixel 812 is located in contact with pixel 811 in the third row and the third column. Pixel 814 is located in contact with pixel 812 in the fourth row and the third column. In this example, the other pixels are of type “3T”, or “4T” or “5T” without bipolar junction transistors and are alternately dedicated, in the 4*4 pixel set, to the green, blue, and red colors.

In the example of FIG. 15C, pixels 811, 812, and 814 are arranged in the same way as in FIG. 15B. In this example, four pixels of “3T”, or “4T”, or “5T” type and dedicated to the green color are arranged on a top left quadrant of 2*2 pixels of the set of 4*4 pixels. Four pixels of “3T”, or “4T”, or “5T” type and dedicated to the red color are arranged on a top right quadrant and four pixels of “3T”, or “4T”, or “5T” type and dedicated to the blue color are arranged on a bottom left quadrant. The pixel in the bottom left corner is of “3T”, or “4T”, or “5T” type and dedicated to the green color.

In the example of FIG. 15D, pixels 811, 812, and 814 are arranged in the same way as in FIG. 15B, while being centered in the middle of the set of 4*4 pixels. In this example, three pixels of “3T”, or “4T”, or “5T” type and dedicated to the green color are arranged in a top left quadrant of the set of 4*4 pixels. Three pixels of “3T”, or “4T”, or “5T” type and dedicated to the red color are arranged in a top right quadrant of the set of 4*4 pixels, three pixels of “3T”, or “4T”, or “5T” type and dedicated to the blue color are arranged in a bottom left quadrant of the set of 4*4 pixels, and four pixels of “3T” or “4T” or “5T” type dedicated to the green color are arranged in a bottom right quadrant of the set of 4*4 pixels.

In the example of FIG. 15E, pixels 811, 812, and 814 are arranged in the same way as in FIG. 15D except that a pixel 1502, similar to pixels 812 or 814 but having its photosensitive circuit element sensitive to all or part of the infrared spectrum, is arranged in contact with pixels 812 and 814 in the third row and the third column of the set of 4*4 pixels.

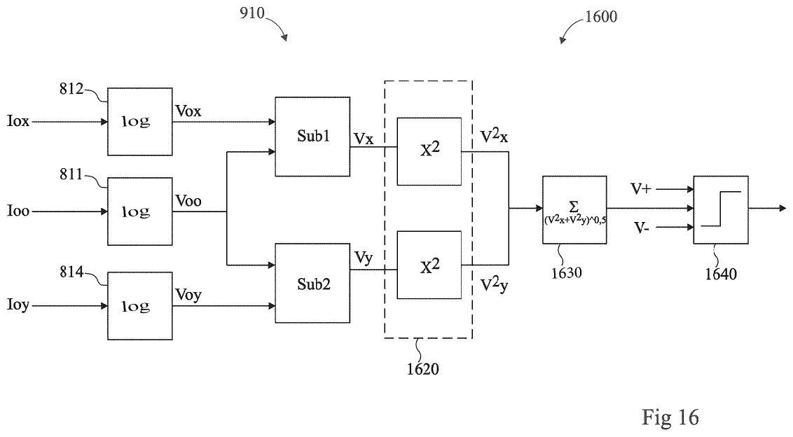

FIG. 16 shows an optoelectronic sensor 1600. Sensor 1600 comprises the same pixels 811, 812, and 814 as FIG. 9, as well as the same subtractor circuit 910.

In the shown example, sensor 1600 comprises a standard calculation block 1620 configured to calculate the square of the output value Vx of the subtractor as well as the square of value Vy.

In the shown example, sensor 1600 comprises a block 1630 configured to add the square of value Vx to the square of value Vy and to take the square root of this sum. The norm is thus calculated.

In the shown example, sensor 1600 comprises a comparator circuit 1630 which compares the calculated norm with one or a plurality of thresholds V+, V−.

The illustrated example enables to obtain a spatial contrast detection, which differs from an event-based temporal contrast detection.

The various described embodiments of pixels can be applied to cameras, image acquisition devices, smartphones, still cameras, but also radars or the like for image acquisition in non-visible domains.

Various embodiments and variants have been described. Those skilled in the art will understand that certain features of these various embodiments and variants may be combined, and other variants will occur to those skilled in the art. In particular, the pixels of the first set of pixels of the example of FIG. 8 may also be pixels of 4T or 5T type respectively implementing 4 or 5 MOS transistors, without diode-connected bipolar junction transistors or with a bipolar, but not diode-connected, transistor. The pixels shown as unshaded in the example of FIG. 12 may also be 3T, 4T, or 5T pixels, respectively implementing 3, 4, or 5 MOS transistors without diode-connected bipolar junction transistors or with bipolar transistors which are not diode-connected. The 3T pixels of FIG. 14 may also be of 4T or 5T type, respectively implementing 4 or 5 MOS transistors with no diode-connected bipolar junction transistors or with bipolar transistors which are not diode-connected.

Finally, the practical implementation of the described embodiments and variants is within the abilities of those skilled in the art based on the functional indications given hereabove. In particular, those skilled in the art will be able to place the pixels having a diode-connected bipolar junction transistor in the pixel array according to their knowledge. Further, the number of pixels having a diode-connected bipolar junction transistor, per pixel array, may vary from a single pixel to all the pixels in the array. The spatial contrast detection may also be achieved with groups of only two diode-connected bipolar junction pixels instead of three, but this generates a lower resolution. Diode-connected pixels with a bipolar junction may be sensitive to wavelengths other than visible light, such as infrared, ultraviolet, or also microwaves. Diode-connected bipolar junction pixels may also be used alone or in groups, without being organized in the form of a pixel array.

Those skilled in the art will be able to implement, according to their knowledge, NPN or PNP bipolar junction transistors, and will vary the circuit connections accordingly.

1. A logarithmic response pixel for an imaging device, the logarithmic response pixel including a photosensitive circuit element and at least one diode-connected bipolar junction transistor coupled to the photosensitive circuit element.

2. The logarithmic response pixel according to claim 1, wherein the at least one diode-connected bipolar junction transistor has a base coupled to a conduction node of the at least one diode-connected bipolar junction transistor.

3. The logarithmic response pixel according to claim 1, wherein the photosensitive circuit element is coupled in series with the at least one bipolar junction transistor between a first terminal and a second terminal, wherein the second terminal is coupled to a terminal of application of a first reference voltage.

4. The logarithmic response pixel according to claim 3, wherein the first terminal is coupled to a terminal of application of a second reference voltage, wherein said second reference voltage is different from the first reference voltage.

5. The logarithmic response pixel according to claim 4, wherein the logarithmic response pixel further comprises:
a current source;
a first transistor coupling the terminal of application of the second reference voltage and a first node coupled to the current source, wherein a control node of the first transistor is coupled to a junction point of the photosensitive circuit element and the at least one diode-connected bipolar junction transistor; and
a second transistor coupling the first node to the current source, the current source being preferably coupled to a column of an optoelectronic sensor.

6. The logarithmic response pixel according to claim 5, further comprising:
an event detection circuit stage;
a capacitive transimpedance amplification circuit stage coupling the event detection circuit stage and the first node;
wherein the event detection circuit stage is configured to modify a value of a storage bit as a function of a voltage present at an output of the capacitive transimpedance amplification circuit stage.

7. The logarithmic response pixel according to claim 6, wherein the event detection circuit stage comprises: at least one comparator circuit configured to detect a variation of the output voltage of the capacitive transimpedance amplification circuit stage with respect to a threshold or a voltage range and reset the capacitive transimpedance amplification circuit stage as a function of this variation.

8. The logarithmic response pixel according to claim 4, wherein the logarithmic response pixel further comprises:
a current source;
a first transistor coupling the terminal of application of the second reference voltage and a first node;
a second transistor coupling the first transistor to the current source;
a third transistor in series with a storage capacitive element between the first terminal and the second terminal, a control node of the third transistor being coupled to a junction point of the photosensitive circuit element and the at least one diode-connected bipolar junction transistor, wherein a control node of the first transistor is coupled to a junction point of the third transistor and the storage capacitive element; and
a fourth transistor coupling a junction point of the third transistor and the storage capacitive element to the second terminal.

9. The logarithmic response pixel according to claim 8, further comprising:
an event detection circuit stage;
a capacitive transimpedance amplification circuit stage coupling the event detection circuit stage and the first node;
wherein the event detection circuit stage is configured to modify a value of a storage bit as a function of a voltage present at an output of the capacitive transimpedance amplification circuit stage.

10. The logarithmic response pixel according to claim 9, wherein the event detection circuit stage comprises at least one comparator circuit configured to detect a variation of the output voltage of the capacitive transimpedance amplification circuit stage with respect to a threshold or a voltage range and reset the capacitive transimpedance amplification circuit stage as a function of this variation.

11. The logarithmic response pixel according to claim 1, wherein:
the photosensitive circuit element is configured to photogenerate holes and is coupled in series with the at least one diode-connected bipolar junction transistor between a first terminal and a second terminal, the second terminal being coupled to a terminal of application of a first reference voltage;
the at least one diode-connected bipolar junction transistor is a PNP-type transistor; and
base and emitter nodes of the at least one diode-connected bipolar junction transistor are coupled together to the second terminal;
wherein the photosensitive circuit element is coupled to the first terminal and the first reference voltage is a negative supply voltage.

12. An optoelectronic sensor, comprising:
an array of pixels including a plurality of linear response pixels and one or more of the logarithmic response pixels according to claim 1.

13. The optoelectronic sensor according to claim 12, wherein the logarithmic response pixels in the array are arranged along diagonals of the array.

14. The optoelectronic sensor according to claim 12:
wherein the photosensitive circuit element is coupled in series with the at least one bipolar junction transistor between a first terminal and a second terminal, the second terminal being coupled to a terminal of application of a first reference voltage;
further comprising:
at least one subtractor circuit configured to perform a first subtraction of a voltage, present on a junction point of the photosensitive circuit element and the at least one diode-connected bipolar junction transistor of a first logarithmic response pixel of the array, to a voltage present on a junction point of the photosensitive circuit element and the at least one diode-connected bipolar junction transistor of a second logarithmic response pixel of the array;
a comparator circuit configured to compare the result of the first subtraction with a first threshold and a second threshold; and
an event-based readout circuit coupled to the comparator circuit.

15. The optoelectronic sensor according to claim 14, wherein:
the at least one subtractor circuit is further configured to perform a second subtraction of the voltage present on a junction point of the photosensitive circuit element and the at least one diode-connected bipolar junction transistor of the second logarithmic response pixel of the array, to a voltage present on a junction point of the photosensitive circuit element and of the at least one diode-connected bipolar junction transistor of a third logarithmic response pixel of the array;
the comparator circuit being configured to compare the result of the second subtraction with said first threshold and said second threshold.

16. The optoelectronic sensor according to claim 14, wherein the at least one subtractor circuit comprises at least one differential amplifier having:
an output coupled to the first terminal of the first pixel;
an inverting input coupled to a junction point of the photosensitive circuit element and the at least one diode-connected bipolar junction transistor of the first pixel;
a non-inverting input coupled to a junction point of the photosensitive circuit element and the at least one diode-connected bipolar junction transistor of the second pixel.

17. The optoelectronic sensor according to claim 14:
wherein the first terminal is coupled to a terminal of application of a second reference voltage different from the first reference voltage;
wherein the at least one subtractor circuit comprises at least one differential amplifier having:
an output coupled to the first node of the first pixel via a first resistor;
an inverting input coupled to the first node of the first pixel; and
a non-inverting input coupled to the first node of the second pixel and to a terminal of application of a third reference voltage via a second resistor.

18. The optoelectronic sensor according to claim 12:
wherein the photosensitive circuit element is coupled in series with the at least one bipolar junction transistor between a first terminal and a second terminal, the second terminal being coupled to a terminal of application of a first reference voltage;
further comprising:
at least one subtractor circuit configured to perform a first subtraction of a voltage, present on the first node of a first logarithmic response pixel of the array, to a voltage present on the first node of a second logarithmic response pixel of the array;
a comparator circuit configured to compare the result of the first subtraction with a first threshold and a second threshold; and
an event-based readout circuit coupled to the comparator circuit.

19. The optoelectronic sensor according to claim 18, wherein:
the at least one subtractor circuit is further configured to perform a second subtraction of the voltage present on the first node of the second logarithmic response pixel of the array, to a voltage present on the first node of a third logarithmic response pixel of the array;
the comparator circuit being configured to compare the result of the second subtraction with said first threshold and said second threshold.

20. The optoelectronic sensor according to claim 18, wherein the at least one subtractor circuit comprises at least one differential amplifier having:
an output coupled to the first terminal of the first pixel;
an inverting input coupled to a junction point of the photosensitive circuit element and the at least one diode-connected bipolar junction transistor of the first pixel;
a non-inverting input coupled to a junction point of the photosensitive circuit element and the at least one diode-connected bipolar junction transistor of the second pixel.

21. The optoelectronic sensor according to claim 18:
wherein the first terminal is coupled to a terminal of application of a second reference voltage different from the first reference voltage;
wherein the at least one subtractor circuit comprises at least one differential amplifier having:
an output coupled to the first node of the first pixel via a first resistor;
an inverting input coupled to the first node of the first pixel; and
a non-inverting input coupled to the first node of the second pixel and to a terminal of application of a third reference voltage via a second resistor.

22. A method of operation of a pixel of an imaging device, comprising:
in response to light excitation of a photosensitive circuit element, generating a logarithmic response of a diode-connected bipolar junction transistor coupled to the photosensitive circuit element.
